(19) United States
(12) Patent Application Publication
(10) Pub. No.: US 2004/0220943 A1
(43) Pub. Date: Nov. 4, 2004

(54) Data structure and method facilitating a custom user interface

(75) Inventors: Douglas E. Ross, Davie, FL (US); Brian M. Elwell, Coral Springs, FL (US); Ajit Mathews, Plantation, FL (US); Ketan M. Shah, Miami, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/426,567

(22) Filed: Apr. 30, 2003

(51) Int. Cl. G06F 7/00

(52) U.S. Cl. 707/100; 707/102

(57) ABSTRACT

A data structure (338) for use in providing a user interface appearance comprises idle screen data (350) corresponding to a first screen appearance and main menu screen data (352) corresponding to a second screen appearance, wherein the idle screen data and the main menu screen data are compiled versions of a text markup language. A method (FIG. 4) for generating the data structure comprises specifying a skin element set (400) and a theme element set (402) and associating each of the displayable items of the theme set with a display location (404) to create a theme description, and compiling to create a binary theme file (406) for customizing a user interface. A communication device (200) uses the data structure for displaying a user interface presentation.

### FIELD OF THE INVENTION

This invention relates in general to a communication devices with a user interfaces, and more specifically to a Data structure and method facilitating a custom user interface.

### BACKGROUND OF THE INVENTION

Communication devices with the ability to minimally customize the user interface exist. Most commonly, a background or a screen saver image may be selected and downloaded to the wireless communication device. Ringtones may be selected and downloaded to many wireless communication devices. These elements are useful in helping a user create a customized user interface appearance but there are several drawbacks. First, the combination of background image, screensaver and ringtone do not represent enough elements of the user interface for the entire ‘look and feel’ or presentation of the user interface to be customized. Second, each of the customized elements are downloaded and activated separately, making the process of updating even these few elements of the user interface cumbersome, time consuming, and error prone. Clearly a need exists for a Data structure and method that will readily support and facilitate a custom user interface for devices, such as communication devices.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a block diagram of a communications system supporting downloadable user interface elements;

FIG. 2 depicts, in a simplified and representative form, a block diagram of a wireless communication device;

FIG. 3 depicts, in a simplified and representative form, the composition of a binary theme file or data structure for facilitating a custom user interface; and

FIG. 4 is a flow chart showing a method for generating a binary theme file.

### DETAILED DESCRIPTION OF PREFERRED EMBODIMENT

In overview, the present disclosure concerns a communications device with a user interface and the data structures and methods facilitating the customization of a user interface for the communication device. More particularly, the use of a data structure, referred to alternatively as a theme file, or binary file or binary theme file, by a communication device for accomplishing the customization of the user interface and a method for creating and utilizing such a data structure are discussed and described. Such customization may include background images, animated images, audio, ringtones, and, on communication devices with color screens, custom color schemes. All major networks such as wireless networks including those based on Code Division Multiple Access (CDMA), Universal Mobile Telephone Service (UMTS), Time Division Multiple Access (TDMA), Global System for Mobile Communications (GSM), and Integrated Digital Enhanced Network (iDEN) are capable of supporting such communication devices, specifically wireless communications devices.

As discussed further below various inventive principles and methods thereof are advantageously employed to allow customization of a user interface by an inventive downloadable file containing a data structure. This allows, in a single operation, the opportunity for a user of a wireless communication device to change all the displayed and audible characteristics of that wireless communication device's user interface, including images such as background, screen saver and icons, sounds, such as ringtones, alert and notification sounds and text fonts. The wireless communication device, or more particularly a user thereof, may use the data structure to create a single focus for the user interface with the graphics representing application selections, the background and screen saver images, the images for screen-defined softkeys, the ringtones and the other alert sounds all compatible with that single focus. An example might be a soccer team theme where the color scheme uses team colors, the graphics show team players, the ring tone and alert tones are cheers or fight songs for that team. Such a capability clearly offers an advantage to a user for creating a personalized user interface beyond the piecemeal efforts of downloading separate ringtones and screen savers.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

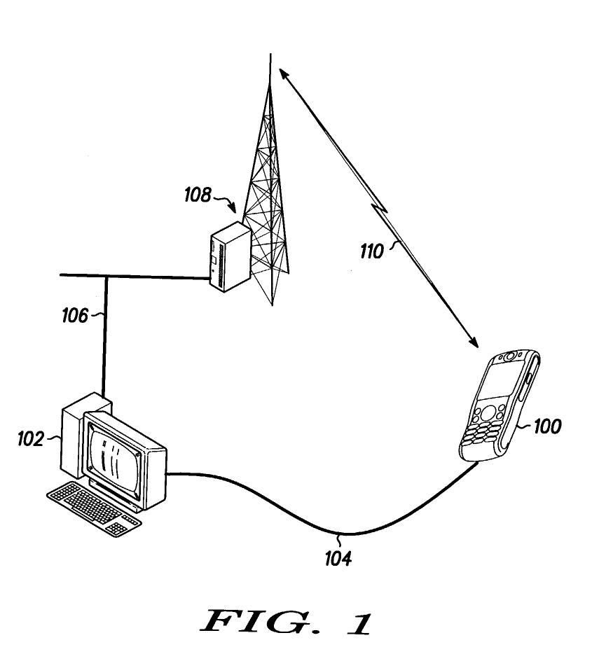

Referring to FIG. 1, a simplified and representative block diagram of a communications system supporting downloadable user interface elements will be discussed and described. A wireless communication device 100 is operable to download a file containing a data structure for use in customizing the presentation of its user interface. The data structure and comprising file may be created on a computer 102 and downloaded to the wireless communication device 100 via a tether or interface cable 104. Alternately, the data structure and corresponding file may be sent via an electronic network 106, such as the Internet or a corporate Intranet, to a wireless network infrastructure 108. From the wireless network infrastructure the file may be downloaded to the wireless communication device 100 over-the-air via a wireless connection as indicated by arrow 110. Note that while much of the discussions below will use a wireless communications unit as an example the concepts and principles disclosed are useful to most user devices with an interface that is fully featured enough to make custom interface features useful, desirable, and practical. For example, personal digital assistants, cellular phones or handsets, hand held computers or calculators, and the like may advantageously utilize the principles discussed below to effect a custom user interface.

The elements of the communication system of FIG. 1 are known and available. The wireless communication device 100 is typical of present and future cellular phones available from manufacturers such as Motorola, Inc. Typical in the category is the Integrated Digital Enhanced Network device, known by the model designation i95. The modifications required to support the additional capabilities described herein are well within the capability of developers engaged in the field and familiar with changes to either the operating system software or, particularly, the user interface software, given the teachings and descriptions provided herein. The computer 102 used to generate the data structure and corresponding file is known and available. For example, a Dell desktop computer running a Microsoft software environment such as Windows 2000 and companion software such as text editors will suffice. The cable 104 is known and available for most brands of wireless communication devices from their respective manufacturers and typically supports a serial link or Universal Serial Bus link. The electronic network 106 is known and available and is typically the Internet or may be an Intranet or other public or private network. The network infrastructure 108 is typical in the wireless communications industry and varies according to the specific installation and technology implemented. Such equipment is available from manufacturers such as Motorola, for example, as Integrated Digital Enhanced Network equipment or other cellular infrastructure equipment.

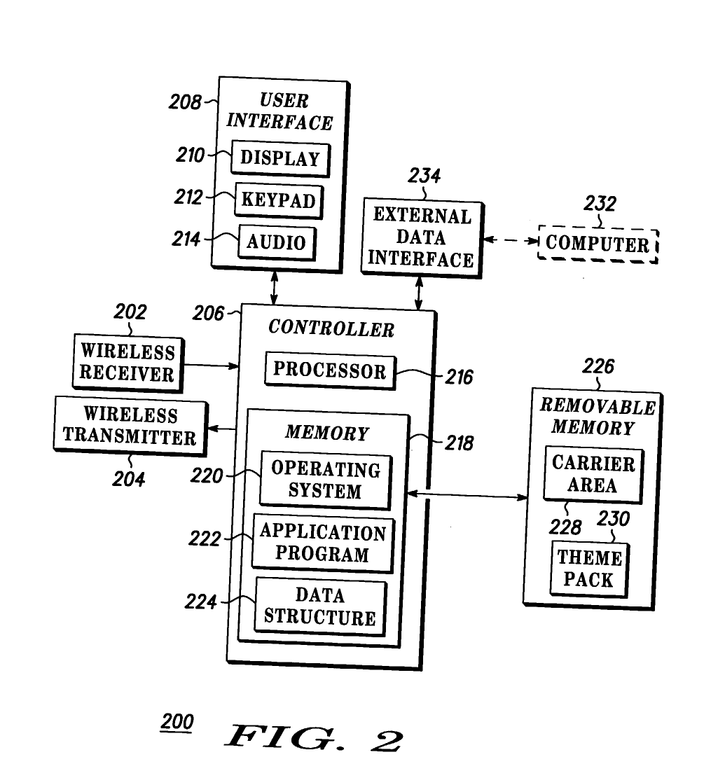

Referring to FIG. 2, a simplified and representative block diagram of a wireless communication device will be discussed and described. A wireless communication device 200 is comprised of a wireless receiver 202 and wireless transmitter 204 for receiving and sending communications. Such communications may include voice and data information. The wireless receiver 202 and wireless transmitter 204 are coupled to a controller 206. The controller 206 manages the operation of wireless communication device 200. The controller 206 is coupled to a user interface 208 comprising a display 210, a keypad 212 or key entry device, and audio circuitry and transducers 214. The controller 206 further comprises a processor 216, which may be or include a digital signal processor (DSP) or general purpose micro processor and a memory 218. The memory 218 comprises both volatile and non-volatile memory and is operable to store data corresponding to the phone operations such as the operating system 220, other wireless communication device applications 222 and a data structure 224. The data structure 224 or binary theme files or theme pack comprising the data structure for user interface customization is discussed in more detail below. Removable memory 226, such as a subscriber identity module (SIM) may be used to transfer and store information. Such cards are typically available from wireless telecommunications service providers and dedicate a portion of their memory to service provider or carrier data 228 but may be useful in storing or transporting theme pack information 230 such as a file containing a data structure for user interface customization as well.

A computer 232 is operable to generate, store and download information corresponding to the customization of the user interface of the wireless communication device 200 and may be coupled to the wireless communication device 200 via a tethered connection 104 or cable via an external data interface 234. The computer 232 maintains the ancillary files needed for assembling and compiling the data structure defining the customized user interface. In addition, the computer 232 generally has access to a great deal more memory and processing power than that of the wireless communication device 200. This allows for a more robust development environment for the creation of a customized user interface.

The components of the wireless communication device 200 are known and available. The wireless receiver 202 and wireless transmitter 204 are available as chipsets from different manufacturers, depending on the modulation, including for example, Motorola, Inc. The controller 206, integrating a processor 216 and memory 218 may include a digital signal processor and microprocessor, each available from Motorola, Inc. and other suppliers. The user interface 208 elements are available in the commodity marketplace. The external data interface 234 is often a port on the controller coupled to a connector on the device. The removable memory 226 is most often a specialized form of a smart card and is available from smart card vendors such as Schlumberger and Gemplus.

In operation, the wireless communication device 200 is arranged and constructed to provide a user interface presentation described by the data structure 224. The wireless communication device 200 utilizes the user interface 208 for displaying the user interface presentation, the memory 218 for storing the data structure 224, and the processor 216, coupled to the memory 218 and the user interface 208, wherein the processor 216 interprets the data structure 224 to provide the user interface presentation. The presentation of the user interface includes all the major elements of the user interface that are perceptible by the user, that is colors, graphics and icons, images, and sounds. The data structure may originate or be developed on the computer 232, where support files, libraries of graphics, images and sounds, and verification programs may exist. The user interface appearance may be defined using a text markup language, such as a variation of XML (eXtensible Markup Language). Text markup languages or other textual descriptive formats are especially useful for environments where memory and processing power are readily available. They are relatively easy to read and maintain and can be useful for data interchange between non-compatible systems as a “least common denominator” data format. However, the use of XML on wireless communication devices is not recommended due to the lack of memory and processing power. Compiling the text markup language information into a machine readable data file greatly reduces the memory requirement in the wireless communication device 200 as well as the processing burden for interpreting the commands of a text markup language.

The data structure 224 is a compiled version of a text markup language to advantageously incorporate the benefits of text markup language in the creation and verification of the user interface appearance and the small size and “processor friendly” nature or execution efficiency of the compiled form. The processor interprets the data structure by differentiating the data structure into one or more of three main data portions, a data substructure, an image substructure and a sound substructure. A user interface program stored in memory 218, most often as part of the operating system 220, is designed to provide the basic wireless communication device 200 user interface functions such as program selection, dialing, message receipt, notification functions, etc. The user interface program is also designed to be executed using, if present, the data structure and its component elements, specifically the data substructure, the image substructure and the sound substructure to provide the user interface presentation in a customized manner.

Other application programs 222, such as a calendar application or a specialized calculator for use in the construction trade, as an example, may be stored in memory 218. The processor 216 is further operable to use the data structure 224 to provide the user interface appearance for these other application programs 224, if so designed. It is possible that a user may want to change the user interface appearance of his or her wireless communication device 200 to reflect different moods or locations, such as work vs. home. The processor is further operable to select, as directed by the user via the user interface, the data structure 224 from a number of data structures stored in the memory 218 to allow the user to rapidly change the user interface appearance.

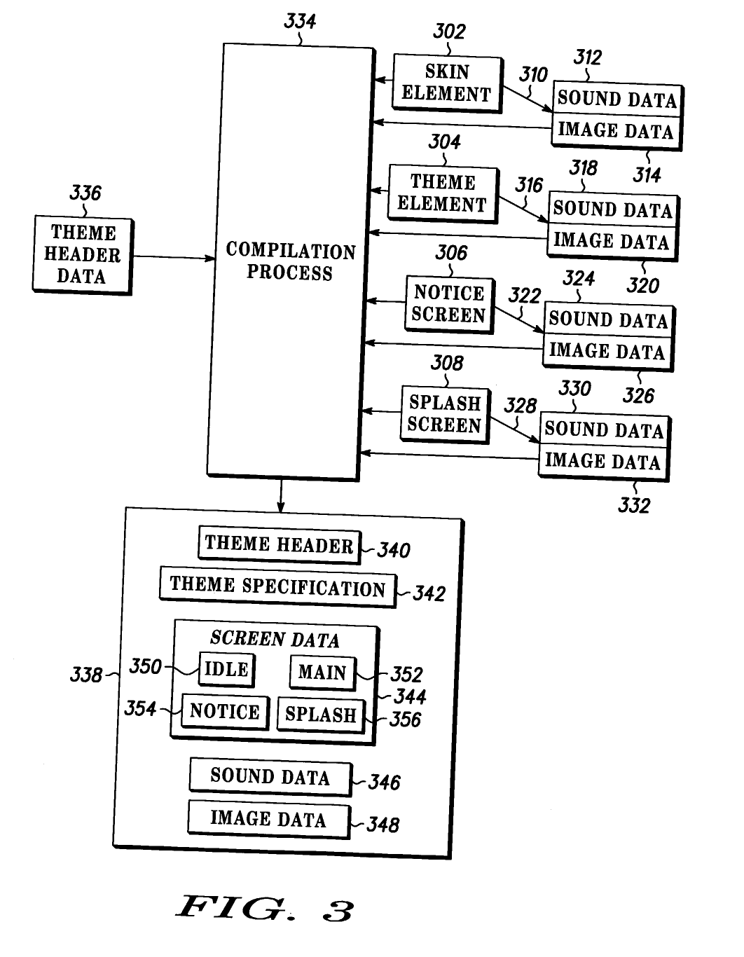

Referring to FIG. 3, a simplified and representative depiction of the composition of a binary theme file or data structure for facilitating a custom user interface will be discussed and described. A text markup language, such as XML (eXtensible markup language) or a compliant or compatible version thereof is used to describe a ‘look and feel’ or appearance of a user interface of a communications device or wireless communication device 200. XML is well documented in current computer science and software engineering literature. In one embodiment, the major elements of the user interface appearance are broken into two major components, a skin element set 302 and a theme element set 304. The skin element set, as documented in the text markup language file, comprises, for example, a color scheme, a background image, and a system font. The theme element set 304 comprises, for example, data corresponding to the layout and visual effects for various pages or screens displayed in response to different system activity and user input. These include the idle screen and main menu screen as described below. Additional information may be included in the description of the user interface appearance such as notice screen data 306, and splash screen data 308. In the development of the text markup language file additional information may be referenced such as sound data and image data. Specifically, a link 310 may be established between sound data 312 and image data 314 related to the skin element set 302. A link 316 may be established between the theme element set 304 and related sound data 318 and image data 320. Similarly a link 322 may be established between the notice screen data 306 and related sound data 324 and image data 326. Lastly a link 328 may be established between the splash screen data 308 and related sound data 330 and image data 332.

A compilation process 334 is used to compile the text markup language description of the user interface appearance comprising the skin element set 302, the theme element set 304, the notice screen data 306, the splash screen data 308 and any linked sound data 312, 318, 324, 330 and image data 314, 320, 326, 332. Theme header data 336 is associated with the text markup language description and is included in the compilation process 334. The result of the compilation process 334 is a data structure 338 comprising binary data. A validation process may be applied in conjunction with the compilation process 334 to help ensure that the information contained in the data structure will be compatible and consistent with the requirements of the user interface program of the wireless communication device 200. This reduces the complexity and overhead of the wireless communication device's 200 user interface program by reducing the number of validation steps required when using the data structure 338 for customizing the user interface.

The data structure 338 can be used by a wireless communication device to provide a user interface appearance. The data structure comprises a theme header 340 having, for example, a release number, a version number and a revision number for tracking the release information useful for software maintenance and specifying wireless communication device model compatibility. The theme header 340 further comprises a phase indication that may be used to distinguish test from production versions of the data structure 338 and a name corresponding to the data structure. The name can be descriptive of the particular data structure, such as ‘Yankees Baseball,’ and may be displayed in one of several languages for aiding user selection of a desired data structure, particularly when more than one is stored in memory 218.

The data structure 338 may also comprise a theme specification 342 having a theme header, a theme idle specification, a theme main menu specification, a theme notice specification, and a theme splash screen specification. These elements of the data structure 338, when present, are used to identify existence and location of corresponding data elsewhere in the data structure 338. It is understood that alternate embodiments of the data structure may use different names for the various elements of the theme header and theme specification while being functionally equivalent.

A typical embodiment of the theme header and theme specification follow:

| | |
|---|---|
| typedef struct | |
| { | |
| UINT32 release; | /* The product the theme was built for |
| */ | |
| UINT32 version; | /* The version of the build */ |
| UINT32 revision; | /* The build revision number */ |
| CHAR phase; | /* This pack was built for R or D Build |
| */ | |

UINT16 name[LANGUAGE][NAME_MAX_LEN]; /* A name for
the theme pack in different Languages*/
}THEME_HEADER_T
typedef struct
{
THEME_HEADER_T *theme_header;
THEME_IDLE_SPEC_T * idle_theme; //
THEME_MAIN_MENU_SPEC_T *main_menu_theme;
THEME_NOTICE_SPEC_T *notice_theme
THEME_SPLASHSCREEN_SPEC_T *splashscreen_theme;
}THEME_SPECIFICATION_T

The data structure 338 comprises three additional main components, screen data 344, sound data 346 and image data 348. The screen data 344 further comprises idle screen data 350, main menu screen data 352, notice screen data 354, and splash screen data 356, each including data in a corresponding data file normally designated as THEME_DATA_T preferably in the following format:

typedef struct_THEME_DATA_T
{

THEME_IMAGESET_T
imageSets[MAX_IMAGE_SETS_PER_THEME];
THEME_APP_SPOTS_T
appSpots[MAX_APP_SPOTS_PER_THEME];

}THEME_DATA_T;

Idle screen data 350 corresponds to a first screen appearance that is displayed on the user interface after a period of inactivity. Idle screen data 350 contains, in a typical embodiment, status data, such as time, general decorative images, and images representing a first set of applications and is used to render an idle screen on the display. These images and status lines are placed on the screen according to the locations specified in the text markup language file used to generate the data structure.

The main menu screen data 352 corresponds to a second screen appearance, such as a main menu screen, that is displayed on the user interface responsive to a user input, typically following an action by the user on the idle screen or another event. The main menu screen may be comprised of a second set of application icons and images corresponding to softkeys, e.g. keys whose function varies with the state of the wireless communication device. The idle screen data 350 and the main menu screen data 352 are interpreted by the wireless communication device, more specifically the processor 216, to provide the user interface appearance. The sound data 346, depending on the links 310, 316 in the text markup description, may correspond to the idle screen or main menu screen and are rendered when a trigger event, such as selection of an icon or a softkey press occurs.

The notice screen data 354 is used to provide a visual indication to a user that an event is occurring or has occurred on the wireless communication device 200 wherein the notice screen data 354 comprises or references an image or images for display on the user interface responsive to an event or events corresponding to actions or activities on the wireless communication device 200. Events may include, in one embodiment for example, an on hook event, an off hook event, a missed call event, a calendar event, an incoming call event, a calling event and a new message event. For each, an image 348 corresponding to the event may be accessed and rendered on the display. In another embodiment, the notice screen data may include or refer to sound data for rendering (playing through appropriate audio transducer) with or instead of the image associated with an event.

The splash screen data 356 corresponds to an image displayed during power cycling of the wireless communication device 200, that is during a power up phase of operation of the wireless communication device or a power down phase of operation of the wireless communication device. The image may be the same or different for power on and off, depending on the implementation. The splash screen data may further comprise or reference sound data. The sound data may be rendered with or instead of the image rendered during power cycling.

The data structure 338, due to its compact size, as compared to a text markup language equivalent, is capable of being conveyed to the wireless communication device 200 by either a computer 102 tethered to the wireless communication device 200 or over-the-air transmission 106. The all-in-one nature of the data structure 338 further lends itself to over-the-air transmission 106 since, unlike other processes, all the screen, sound and image data is contained in the data structure 338.

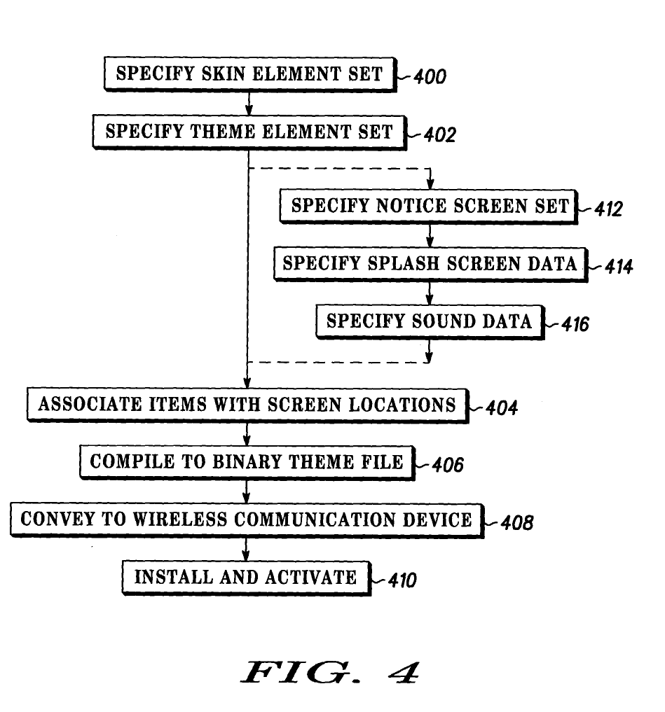

Referring to FIG. 4 a flow chart showing a method for generating a binary theme file is discussed and described. The method comprises specifying a skin element set 400. The skin element set is information that pertains to the appearance of a screen, that is, a color scheme, a background image and a font for rendering system and default text. If the skin element set is not selected, the elements referred to in a skin element set are set to default values or states supplied in the wireless communication device. At 402, a theme element set may then be specified. The theme element set comprises an image, an image memory address, another background image for use as an alternate to that specified in the skin element set, and a sound file.

The theme element set is used to create a consistent look or appearance available for use by both the base wireless communication device functions as well as any participating applications that may be run on the wireless communication device. The skin element set and theme element set, for example, can be based on a sport, such as soccer or baseball, or an animal, for example a tiger, etc. The skin element set and theme element set may follow a single focus or theme. A wireless communication device may use a theme to create a single focus for the user interface with the graphics representing application selections, the background and screen saver images, images for screen-defined soft keys, ringtones and other alert sounds all compatible with that single focus. After specifying the theme element set, each of the theme element set displayable items is associated with a location on a display of the wireless communication device to create a theme description 404. For example, an image may be set for display from the top right corner to a point n pixels down and m pixels to the left of the top right corner. Non-displayable elements such as sounds may be associated with soft key actions or other sound triggering events. The skin element set, the theme element set, and the theme description, is compiled 406 to a binary format to create a binary theme file wherein the binary theme file is usable for customizing a user interface on a wireless communication device 200. The binary theme file may be conveyed 408 to a wireless device 200 by any of several means, including a tethered 104 or wireline connection from a computer or via an over-the-air 110 (OTA) transfer. Once received by the wireless communication device 200 the binary theme file can be installed and activated 410 for use by the wireless communication device 200 in presenting a customized user interface. If so constructed around a theme, the use of the binary theme file will result in a presentation to the user of the wireless communication device 200 of a theme oriented user interface. In one embodiment, the format of the binary theme file can be a Motorola S-Record format, publicly documented and available. A number of other formats for the binary theme file may be envisioned based, in part, on considerations of size, security and processor type.

Additional information may be specified for the binary theme file. A notice screen set may be specified 412. The notice screen comprises an image or images corresponding to one or more events on the wireless communication device 200, such as an unanswered call, a message waiting or a calendar appointment. The notice screen set, if specified, is compiled 406 into the binary theme file.

A splash screen may be specified 414. The splash screen comprises an image for display, for example, during power cycling, that is turning the power off or on in the operation of the wireless communication device 200. Similar to the above, the splash screen data will be compiled 406 into the binary theme file.

Sound data may be specified 416 and compiled 406 into the binary theme file for use by the wireless communication device 200 as an audible signal, rendered responsive to a predetermined activity of the wireless communication device 200, such as when a message arrives.

The processes, apparatus, and systems, discussed above, and the inventive principles thereof are intended to and will enhance the experience of a user of a wireless communication device by making customization of the user interface convenient and comprehensive. Using the advantages inherent in text markup languages to specify and build a description of a theme-based user interface and combining that with the size, speed and transportability of a binary file will greatly improve the availability and delivery of customized user interfaces to wireless communication devices. The use of the single binary theme file and its component data structure to convey all aspects of customization of the user interface are a measurable improvement over individually downloading and installing each of the elements of the user interface such as sounds and images. This improvement is noticeable not only by the user in the downloading process but by a retailer in the reduced handling of files and increased revenue opportunity represented by the comprehensive binary theme file.

Further the user can store and activate multiple themes represented by multiple binary theme files at different times to suit his or her mood or location. The theme may also be carried over from not only the base wireless communication device operation, such as making and receiving calls, but also cooperative applications capable of using the currently selected binary theme file.

Various embodiments of methods and apparatus for creating and using text markup languages to create a validated binary theme file for customizing the user interface appearance of a wireless communication device have been discussed and described. It is expected that these embodiments or others in accordance with the present invention will have application to many wireless communication device and other portable electronic devices with customizable user interfaces. The disclosure extends to the constituent elements or equipment comprising such systems and specifically the methods employed thereby and therein.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A data structure for use by a electronic device to provide a user interface appearance comprising:
idle screen data corresponding to a first screen appearance that is displayed on a user interface after a period of inactivity;
main menu screen data corresponding to a second screen appearance that is displayed on the user interface responsive to a user input;
wherein the idle screen data and the main menu screen data are compiled versions of a text markup language for interpretation by the electronic device to provide the user interface appearance.

2. The data structure of claim 1 further comprising sound data corresponding to one of the idle screen data and the main menu screen data.

3. The data structure of claim 1 further comprising notice screen data corresponding to an event on the electronic device, wherein the notice screen data comprises an image for display on the user interface responsive to an event.

4. The data structure of claim 3 wherein the image corresponds to one of an on hook event, an off hook event, a missed call event, a calendar event, an incoming call event, a calling event and a new message event.

5. The data structure of claim 3 wherein the notice screen data further comprises sound data.

6. The data structure of claim 1 further comprising splash screen data corresponding to an image displayed during one of a power up phase of operation of the electronic device and a power down phase of operation of the electronic device.

7. The data structure of claim 6 wherein the splash screen data further comprises sound data.

8. The data structure of claim 1 further capable of being conveyed to the electronic device by one of a computer and an over-the-air transmission.

9. The data structure of claim 1 further comprising a theme specification having one of a theme header, a theme idle specification, a theme main menu specification, a theme notice specification, and a theme splash screen specification.

10. The data structure of claim 1 further comprising a theme header having one of a release number, a version number, a revision number, a phase indication; and a name.

11. A method for generating a binary theme file for use in a electronic device comprising:
specifying a skin element set;
specifying a theme element set;
associating each of a plurality of displayable items of the theme element set with a location on a display to create a theme description; and
compiling the skin element set, the theme element set, and the theme description to create a binary theme file wherein the binary theme file is usable for customizing a user interface for the electronic device.

12. The method of claim 11 wherein the specifying the skin element set further comprises:
specifying the skin element set to comprise one of a color scheme, a background image, and a system font.

13. The method of claim 11 wherein the specifying the theme element set further comprises:
specifying the theme element set to comprise one of an image, an image memory address, an other background image, and a sound file.

14. The method of claim 11 further comprising specifying a notice screen set, wherein the notice screen set comprises an image corresponding to an event on the electronic device.

15. The method of claim 11 further comprising specifying splash screen data, wherein the splash screen data is compiled into the binary theme file and comprises an image for display during power cycling.

16. The method of claim 11 further comprising specifying sound data, wherein the sound data is compiled into the binary theme file and rendered responsive to a predetermined activity of the electronic device.

17. The method of claim 11 further comprising:
conveying the binary theme file to the electronic device; and
installing the binary theme file for use in customizing the user interface.

18. A communication device arranged and constructed to provide a user interface presentation described by a data structure comprising:
a user interface for displaying the user interface presentation;
a memory for storing the data structure, wherein the data structure is a compiled version of a text markup language; and
a processor, coupled to the memory and the user interface, wherein the processor interprets the data structure to provide the user interface presentation.

19. The communication device of claim 18 wherein the processor interprets the data structure by:
differentiating the data structure as one of a data substructure, an image substructure and a sound substructure; and
executing a user interface program using the one of the data substructure, the image substructure and the sound substructure to provide the user interface presentation.

20. The communication device of claim 18 wherein:
the memory is further operable to store an application program; and
the processor is further operable to use the data structure to provide the user interface presentation for the application program.

21. The communication device of claim 18 wherein the processor is further operable to select the data structure from a plurality of data structures stored in the memory.
